(19) United States
(12) Patent Application Publication
(10) Pub. No.: US 2024/0045203 A1
(43) Pub. Date: Feb. 8, 2024

(54) IMAGE PROJECTION SYSTEM AND IMAGE PROJECTION METHOD

(71) Applicant: KOITO MANUFACTURING CO., LTD., Tokyo (JP)

(72) Inventor: Toshiaki TSUDA, Shizuoka (JP)

(21) Appl. No.: 18/255,972

(22) PCT Filed: Dec. 2, 2021
(86) PCT No.: PCT/JP2021/044225

§ 371 Date: Jun. 5, 2023

(30) Foreign Application Priority Data
Dec. 14, 2020 (JP) 2020-206894

(51) Int. Cl. G02B 27/01

(52) U.S. Cl. CPC G02B 27/01; G02B 2027/014; G02B 2027/0196; G02B 2207/101

(57) ABSTRACT

Provided are an image projection system and an image projection method capable of ensuring the visibility of a virtual image projected in superposition with a background even under various traveling conditions. The image projection system includes a transmission reflection unit that includes a translucent member, an image projection unit (10) that irradiates an inner surface of the transmission reflection unit with light including image information to project a display image, an outside condition imaging unit (50) that images, as an outside image, a condition outside the transmission reflection unit, a display area specifying unit (61) that specifies a display area where the display image is projected in the outside image, an image determination unit (62) that sets a determination area including the display area and recognizes and analyzes an image in the determination area in the outside image, and an image adjustment unit (63) that adjusts the image information based on an analysis result of the image determination unit.

### TECHNICAL FIELD

The present invention relates to an image projection system and an image projection method, and particularly relates to an image projection system and an image projection method for displaying an image to, e.g., a driver in a vehicle.

### BACKGROUND ART

In recent years, a driving support technique and an automatic driving technique in which a computer is responsible for part or the entirety of driving operation such as steering and acceleration/deceleration of a vehicle have been developed. In addition, also in manual driving in which a human performs driving operation of a vehicle, a traveling support technique has been developed, in which a plurality of various sensors and communication devices are mounted on the vehicle to obtain information on the state of the vehicle and a condition therearound to improve safety and comfortability during traveling.

In this driving support technique, automatic driving technique, or traveling support technique, various types of information obtained, such as the state of the vehicle, the condition therearound, and the status of driving operation of the computer, are presented to the driver using meters or a display device. In the related art, in order to present various types of information, characters and images are generally displayed on the meters or the display device in the vehicle.

However, it is not preferable to present information with the meters or display device provided in the vehicle because the driver needs to look at the meters or the display device while shifting the line of sight from the front in a traveling direction. For this reason, in order to present image information while reducing the shift of the line of sight from the front of the vehicle, a head up display (HUD) device that projects an image on a windshield of the vehicle and allows the driver to visually recognize reflected light has been proposed (see, e.g., Patent Document 1).

In the HUD device of the related art, a virtual image projected from an image projection unit via a transparent member such as the windshield is visually recognized, and is superimposed on the background in a real space. With this configuration, the driver can visually recognize various types of information (virtual images) projected from the image projection unit within a single field of view while visually recognizing an object in the real space outside the vehicle.

### CITATION LIST

### Patent Literature

Patent Document 1: JP-A-2019-119262

### SUMMARY OF INVENTION

### Problems to be Solved by Invention

In the HUD device of the related art, in order to ensure the visibility of the virtual image projected in superposition with the background, brightness outside the vehicle is measured by, e.g., an optical sensor, and the intensity of light emitted from the image projection unit is controlled according to the brightness of the outside space. Thus, the brightness of the light for projecting the virtual image is increased in bright environment during the day and decreased in dark environment during the night, so that contrast between the background and the virtual image is controlled within a proper range.

However, in the HUD device of the related art described above, in, e.g., environment where light and dark on a road surface are switched, the brightness around the vehicle does not always match the brightness of the background, and therefore, the visibility may be degraded. For example, in a case where the vehicle travels in a dark tunnel and approaches a tunnel exit during daytime traveling, a case where a rear portion of a preceding vehicle is illuminated with a headlight during nighttime traveling, or a case where light from a headlight of an oncoming vehicle is reflected on a road surface during nighttime traveling, the intensity of light from the image projection unit decreases due to the darkness around the vehicle, and the visibility cannot be favorably maintained with the image superimposed on the bright background.

Even in a case where a difference in brightness between the periphery of the vehicle and the background is small, the light for projecting the virtual image is inconspicuous in comparison with the background depending on the traveling state of the vehicle, and there is a possibility that the visibility of the virtual image is degraded. For example, in a case where the vehicle is traveling on a snowy road, a case where dropped leaves are dispersed on a road surface during an autumn foliage period, a case where the vehicle is traveling on a mountain road in the season of fresh green, a case where the vehicle is traveling along a coast, or a case where the vehicle is traveling in a dense fog, it is difficult to favorably maintain the visibility by projection with light having a color tone similar to that of an area where the virtual image is superimposed or the background of the field of view.

Thus, the present invention has been made in view of the above-described problems of the related art, and is intended to provide an image projection system and an image projection method capable of ensuring the visibility of a virtual image projected in superposition with a background even under various traveling conditions.

### Solution to Problems

In order to solve the above-described problems, the image projection system of the present invention includes a transmission reflection unit that includes a translucent member, an image projection unit that irradiates an inner surface of the transmission reflection unit with light including image information to project a display image, an outside condition imaging unit that images, as an outside image, a condition outside the transmission reflection unit, a display area specifying unit that specifies a display area where the display image is projected in the outside image, an image determination unit that sets a determination area including the display area and recognizes and analyzes an image in the determination area in the outside image, and an image adjustment unit that adjusts the image information based on an analysis result of the image determination unit.

In such an image projection system of the present invention, the outside condition imaging unit captures the outside image, and the display image is adjusted and projected from the image projection unit based on the analysis result of the image in the determination area. Thus, it is possible to ensure the visibility of the virtual image projected in superposition with the background even under various traveling conditions.

In one aspect of the present invention, a plurality of the display areas and a plurality of the determination areas are provided.

In one aspect of the present invention, the image determination unit acquires brightness information in the determination area, and the image adjustment unit adjusts the brightness of the image information based on the brightness information.

In one aspect of the present invention, the image determination unit acquires color tone information in the determination area, and the image adjustment unit adjusts the color tone of the image information based on the color tone information.

In one aspect of the present invention, the image determination unit analyzes a plurality of images in the determination area within a determination period.

In one aspect of the present invention, the image determination unit sets the determination period based on the image information.

In one aspect of the present invention, the image projection system further includes a condition acquisition unit that acquires an outside condition as condition information, and the image determination unit sets the determination period based on the condition information.

In one aspect of the present invention, the outside condition imaging unit includes a visible light imaging unit that captures a visible light image with visible light and an infrared light imaging unit that captures an infrared light image with infrared light, and the outside image includes the visible light image and the infrared light image.

In one aspect of the present invention, the infrared light imaging unit includes an infrared pulsed light source that emits the infrared light in a pulse form, and the infrared light image is captured after a first delay time has elapsed from the end of light emission from the infrared pulsed light source.

In one aspect of the present invention, the visible light image is captured after a second delay time has elapsed from the end of capturing of the infrared light image.

In one aspect of the present invention, the image adjustment unit superimposes at least part of the infrared light image on the image information.

In one aspect of the present invention, the image determination unit extracts a feature area based on a difference between the visible light image and the infrared light image, and the image adjustment unit superimposes the feature area on the image information.

In one aspect of the present invention, the infrared light imaging unit and the visible light imaging unit are configured such that a visible light subpixel and an infrared light subpixel are mixed in a single image sensor.

In one aspect of the present invention, the transmission reflection unit is a windshield of a vehicle.

In order to solve the above-described problems, the image projection method of the present invention includes an image projection step of irradiating an inner surface of a transmission reflection unit, which includes a translucent member, with light including image information to project a display image, an outside condition imaging step of imaging, as an outside image, a condition outside the transmission reflection unit, a display area specifying step of specifying a display area where the display image is projected in the outside image, an image determination step of setting a determination area including the display area and recognizing and analyzing an image in the determination area in the outside image, and an image adjustment step of adjusting the image information based on an analysis result of the image determination step.

### Effects of Invention

The present invention can provide an image projection system and an image projection method capable of ensuring the visibility of a virtual image projected in superposition with the background even under various traveling conditions.

### BRIEF DESCRIPTION OF DRAWINGS

FIG. 1 is a schematic view showing the configuration of an image projection system according to a first embodiment;

FIG. 2 is a block diagram showing the configuration of the image projection system according to the first embodiment;

FIG. 3 is a schematic view showing a relationship between an outside image captured by an outside condition imaging unit 50 and a display area in the image projection system according to the first embodiment;

FIG. 4 is a flowchart describing the procedure of an image projection method according to the first embodiment;

FIG. 5 is a schematic view showing a relationship between a determination area and a display area in an image projection system according to a second embodiment, FIG. 5(a) showing a plurality of display areas 53a to 53c in a determination area 52 and FIG. 5(b) showing sub-determination areas 54a to 54c corresponding to the display areas 53a to 53c;

FIG. 6 is a schematic view showing the configuration of an image projection system according to a fourth embodiment;

FIG. 7 is a block diagram showing the configuration of the image projection system according to the fourth embodiment;

FIG. 8 is a schematic view showing a relationship between a determination area and a display area in the image projection system according to the fourth embodiment, FIG. 8(a) showing a determination area 52a in a visible light image, FIG. 8(b) showing a determination area 52b in an infrared light image, FIG. 8(c) showing a comparative image 52c of the visible light image and the infrared light image, and FIG. 8(d) showing a point-of-view image 52d of an occupant e in which a virtual image 40 is superimposed on the background;

FIG. 9 is a flowchart describing the procedure of an image projection method according to the fourth embodiment; and

FIG. 10 is a timing chart describing pulsed light emission and imaging in the fourth embodiment, FIG. 10(a) showing the timing of light emission from an infrared pulsed light source 50c, FIG. 10(b) showing the timing of imaging by an infrared light imaging unit 50b, and FIG. 10 (c) showing the timing of imaging by a visible light imaging unit 50a.

### DESCRIPTION OF EMBODIMENTS

### First Embodiment

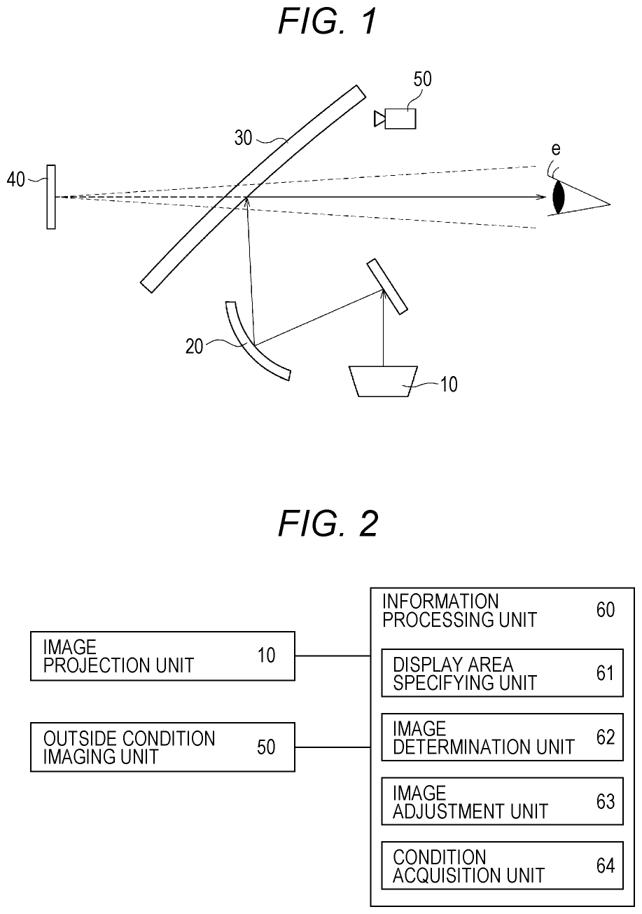

Hereinafter, embodiments of the present invention will be described in detail with reference to the drawings. The same or equivalent components, members, and processes shown in the drawings are denoted by the same reference numerals, and overlapping description thereof will be omitted as necessary. FIG. 1 is a schematic view showing the configuration of an image projection system according to the present embodiment. FIG. 2 is a block diagram showing the configuration of the image projection system according to the present embodiment.

As shown in FIGS. 1 and 2, the image projection system of the present embodiment includes an image projection unit 10, a projection optical unit 20, a transmission reflection unit 30, an outside condition imaging unit 50, and an information processing unit 60, and projects a virtual image 40 to form an image in a space. The information processing unit 60 is connected to the image projection unit 10 and the outside condition imaging unit 50 so as to communicate information therebetween.

The image projection unit 10 is a device that emits, in response to a supply of a signal containing image information from the information processing unit 60, light containing the image information to form the virtual image 40 at a predetermined position. The light emitted from the image projection unit 10 enters the projection optical unit 20. Examples of the image projection unit 10 include a liquid crystal display device, an organic EL display device, a micro LED display device, and a projector device using a laser light source.

The projection optical unit 20 is an optical member having a focal point at a position separated by a predetermined focal length. The light emitted from the image projection unit 10 is reflected on the projection optical unit 20, and reaches the transmission reflection unit 30. Although FIG. 1 shows an example where a plane mirror and a concave mirror are used as the projection optical unit 20 and the light from the image projection unit 10 is reflected to the transmission reflection unit 30, a transmission lens may be used as the projection optical unit 20. In addition, FIG. 1 shows an example where the light emitted from the image projection unit 10 directly reaches the projection optical unit 20 including the plane mirror and the concave mirror. However, the reflected light may reach the projection optical unit 20 by using, e.g., more plane mirrors or a plurality of concave mirrors.

The transmission reflection unit 30 is a member that transmits light from the outside and reflects the light received from the projection optical unit 20 in a direction toward an occupant e. In a case where the image projection system is used for a vehicle information display device, a windshield of a vehicle can be used as the transmission reflection unit 30. A combiner may be prepared separately from the windshield, and may be used as the transmission reflection unit 30. Alternatively, a shield of a helmet, goggle, or glass may be used as the transmission reflection unit 30.

The virtual image 40 is an aerial stereoscopic image that is visually recognized as if formed in the space when the light reflected by the transmission reflection unit 30 reaches the occupant e. A position at which the virtual image 40 is formed is determined by a spread angle when the light emitted from the image projection unit 10 travels in the direction toward the occupant e after having been reflected by the projection optical unit 20 and the transmission reflection unit 30.

The outside condition imaging unit 50 is a device that images, as an outside image, a condition on the opposite side (outside) of the occupant e via the transmission reflection unit 30. The configuration of the outside condition imaging unit 50 is not limited, and a well-known imaging device such as a charge coupled device (CCD) sensor or a complementary metal oxide semiconductor (CMOS) sensor can be used. The outside image captured by the outside condition imaging unit 50 is preferably a color image whose gradation can be expressed to such an extent that the brightness or color can be specifically distinguished.

The direction of imaging by the outside condition imaging unit 50 is an outward direction in which the image is visually recognized by the occupant e through the transmission reflection unit 30, and for example, is a vehicle traveling direction (forward). Examples of a position at which the outside condition imaging unit 50 is mounted include one on the front of the vehicle and one inside a vehicle compartment, but the image is preferably captured in an imaging area close to the line-of-sight direction of the occupant e and the position of the outside condition imaging unit 50 is preferably one above the head of the occupant e, one near an upper portion of the transmission reflection unit 30, or one on a dashboard of the vehicle, for example. The outside condition imaging unit 50 includes an information communicator that communicates information with the information processing unit 60, and transmits information on the captured outside image to the information processing unit 60.

As shown in FIG. 1, in the image projection system of the present embodiment, the light including the image information is emitted from the image projection unit 10 toward the projection optical unit 20. The light emitted from the image projection unit 10 is reflected on the inner surfaces of the projection optical unit 20 and the transmission reflection unit 30, and enters the eyes of the occupant e. At this time, the light reflected from the transmission reflection unit 30 spreads toward the occupant e so that the occupant e can visually recognizes that the virtual image 40 is formed at a position farther from the occupant e than the transmission reflection unit 30 is. In addition, the occupant e visually recognizes the background on the extension of the line of sight in a state in which the virtual image 40 is superimposed thereon. At the same time, the outside condition imaging unit 50 images, as the outside image, the outside of the transmission reflection unit 30, and transmits data on the outside image to the information processing unit 60. As will be described later, the information processing unit 60 adjusts the image projected from the image projection unit 10 based on the outside image to improve visibility.

The information processing unit 60 is a unit that processes various types of information according to a predetermined procedure, and is a computer including a central processing unit (CPU), a memory, an external storage device, and various interfaces. As shown in FIG. 2, the information processing unit 60 includes a display area specifying unit 61, an image determination unit 62, an image adjustment unit 63, and a condition acquisition unit 64. These units are implemented in such a manner that the CPU performs information processing based on programs recorded in the memory and external storage device of the information processing unit 60. The information processing unit 60 includes an information communicator that communicates information between the image projection unit 10 and the outside condition imaging unit 50.

The display area specifying unit 61 is a unit that acquires the outside image captured by the image projection unit 10 and specifies, as a display area, an area where a display image (virtual image 40) is projected so as to be superimposed in the outside image. Here, in a method for specifying the display area by the display area specifying unit 61, the display area can be obtained from a correspondence relationship between the imaging area of the outside condition imaging unit 50 and a viewing angle from the point-of-view position of the occupant e. More specifically, the display area is calculated by defining, as an irradiation position, a position irradiated with the light from the image projection unit 10 in the transmission reflection unit 30 and defining, as a line-of-sight vector, a straight line connecting the irradiation position and the point-of-view position of the occupant e that has been assumed in advance. In addition, a relative positional relationship between the mount position of the outside condition imaging unit 50 and the transmission reflection unit 30 is recorded in advance, and the background visually recognized by the occupant e and the position in the outside image are calculated from the imaging area of the outside condition imaging unit 50 and the line-of-sight vector. In this manner, the display area is specified.

The image determination unit 62 is a unit that sets a determination area including the display area and recognizes and analyzes an image in the determination area in the outside image. Since the occupant e visually recognizes the display image on the background, an area broader than the display area on which the virtual image 40 is superimposed is set as the determination area. The image determination unit 62 analyzes the brightness and color tone of the outside image from the image in the determination area, and acquires brightness information and color tone information. The acquired brightness information and color tone information are transmitted to the image adjustment unit 63. Analysis of the brightness information and the color tone information will be described later.

The image adjustment unit 63 is a unit that adjusts the image information based on an analysis result of the image determination unit 62. Based on the brightness information and color tone information analyzed by the image determination unit 62, the brightness or the color tone is adjusted in the image information on the display image emitted from the image projection unit 10. Here, adjustment of the image information may be physical adjustment such as increasing or decreasing the amount of light emitted from the image projection unit 10 or inserting a color filter into the path of light emitted from the image projection unit 10. Alternatively, image processing may be performed on digital data of the image information to change the brightness, the contrast, or the color tone and synthesize an image.

The condition acquisition unit 64 is a unit that acquires an outside condition as condition information and transmits the condition information to each unit. Examples of the outside condition acquired by the condition acquisition unit 64 include a vehicle traveling speed, a weather condition, position information on the vehicle, presence of an alert target, and traffic information. Examples of a technique of acquiring these conditions include a vehicle speed sensor, a global positioning system (GPS) device, a wireless communicator, a navigation system, and outside image recognition.

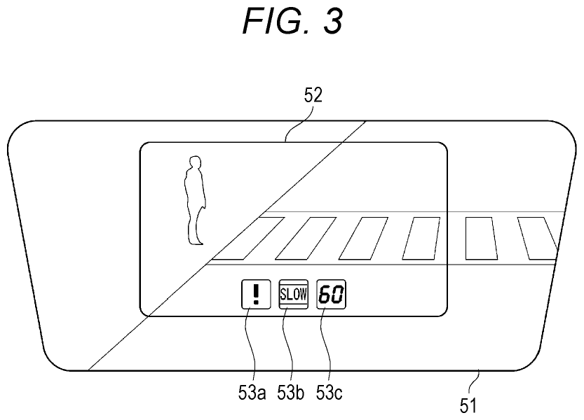

FIG. 3 is a schematic view showing a relationship between the outside image captured by the outside condition imaging unit 50 and the display area in the image projection system according to the first embodiment. In FIG. 3, an outside image 51 captured by the outside condition imaging unit 50 and a determination area 52 in the outside image 51 are indicated by solid line frames. In addition, a plurality of display areas 53a, 53b, 53c is provided in the determination area 52, and icons are each projected as virtual images 40 which are display images in the display areas 53a, 53b, 53c.

Here, a correspondence between the outside image 51 and the background visually recognized by the occupant e through the transmission reflection unit 30 is calculated as described above, and the display areas 53a, 53b, 53c and the virtual images 40 on the background visually recognized by the occupant e are superimposed such that the positions thereof are coincident with each other in the outside image 51. Thus, the virtual images 40 on the background visually recognized by the occupant e through the transmission reflection unit 30 are similar to those in the schematic view shown in FIG. 3.

The occupant e is looking ahead of the vehicle through the transmission reflection unit 30, and visually recognizes the conditions of a road surface and a road shoulder in the front of the vehicle. At this point, the line of sight is more concentrated on the front of an on-board position or in an area near the center of the transmission reflection unit 30 (windshield). Thus, the determination area 52 set by the image determination unit 62 is an area including the display areas 53a, 53b, 53c and including the front of the occupant e and an area near the center of the transmission reflection unit 30. In the present embodiment, the image adjustment unit adjusts the image information based on the brightness information and color tone information on the determination area and forms an image superimposed with the image in the determination area, so that the visibility of the virtual image 40 is improved.

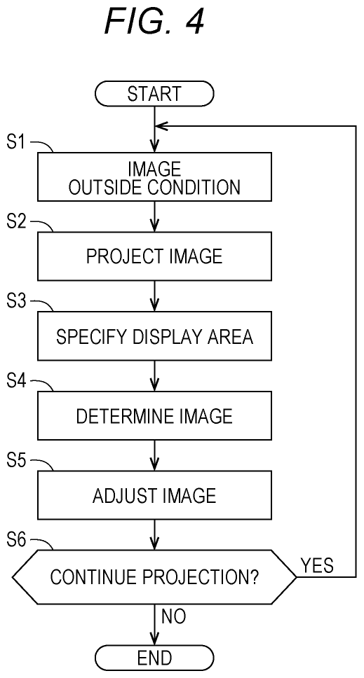

FIG. 4 is a flowchart describing the procedure of an image projection method according to the present embodiment. In the image projection system of the present embodiment, the functions of the display area specifying unit 61, the image determination unit 62, the image adjustment unit 63, and the condition acquisition unit 64 are implemented in such a manner that the information processing unit 60 is activated to read the program recorded in the external storage device into the memory and process the information with the CPU. Further, the image projection unit 10, the outside condition imaging unit 50, and various other devices are connected to the information processing unit 60, and drive and control of each unit and information communication therebetween are performed.

Step S1 is an outside condition imaging step of the outside condition imaging unit 50 imaging, as an outside image, the condition outside the transmission reflection unit 30. The information processing unit 60 drives and controls the outside condition imaging unit 50 to image the outside condition and acquire the outside image. After the outside image has been acquired, the process proceeds to Step S2.

Step S2 is an image projection step of emitting the light including the image information from the image projection unit 10 to form the virtual image 40 at the predetermined position. Here, the image information includes information obtained by conversion of an image into digital data and correction data regarding the brightness or the color tone. The image projection unit 10 creates an image shape based on the digital data of the image included in the image information, and controls the brightness or color tone of the light to be emitted based on the brightness or color tone of the correction data. Accordingly, the light forming the virtual image 40 is emitted from the image projection unit 10 with the intensity and color tone of light according to the image information. After the image projection unit 10 has emitted the light for projecting the virtual image 40, the process proceeds to Step S3.

Step S3 is a display area specifying step of specifying, as the display area, the area where the display image is projected so as to be superimposed in the outside image. As described above, the display area specifying unit 61 obtains the display area in the outside image from the correspondence relationship between the imaging area of the outside condition imaging unit 50 and the viewing angle of the occupant e. The imaging area of the outside condition imaging unit 50 may be calculated from the attachment position of the outside condition imaging unit 50 and the optical axis direction of the lens and be recorded in advance, or may be calculated from a relative positional relationship between the attachment position and part of the vehicle included in the outside image that has been extracted by, e.g., image recognition. After the display area specifying unit 61 has specified the display area in the outside image, the process proceeds to Step S4.

Step S4 is an image determination step of setting the determination area including the display area in the outside image and recognizing and analyzing an image in the determination area. The image determination unit 62 sets, as the determination area, a broad area including the display area in the outside image, and analyzes the image in the determination area to acquire the brightness information and the color tone information on the determination area. Here, in setting of the determination area, an area corresponding to a predetermined area in the transmission reflection unit 30 may be recorded in advance as the determination area, or the image determination unit 62 may set the determination area based on the condition acquired by the condition acquisition unit 64. In the example shown in FIG. 3, the determination area is set so as to include the front of the occupant e where the line of sight of the occupant e is likely to be concentrated and the center area of the transmission reflection unit 30.

Examples of a method for acquiring the brightness information and the color tone information by the image determination unit 62 include a method in which the brightness and the color are specified for each pixel of the image included in the determination area and an average value across the entire determination area is calculated to obtain the brightness information and the color tone information. Alternatively, the brightness and color tone of the pixel may be ranked across the entire determination area, and the rank representing the largest number of pixels may be taken as the brightness information and the color tone information. The brightness information and the color tone information may be calculated by image recognition of the image in the determination area by machine learning. After the image determination unit 62 has acquired the brightness information and the color tone information in the determination area, the process proceeds to Step S5.

Step S5 is an image adjustment step of adjusting the image information on the virtual image 40 projected from the image projection unit 10 based on the analysis result in the image determination step. The image adjustment unit 63 adjusts the image information to be projected by the image projection unit 10 based on the brightness information and color tone information acquired by analysis of the determination area by the image determination unit 62. Accordingly, in the example shown in FIG. 3, the brightness and color tone of the entire determination area 52 can be understood, and the virtual image 40 with a high visibility can be superimposed according to the brightness and the color tone. Here, since the determination area 52 does not match the brightness or color tone of the periphery of the vehicle, but substantially matches the outside background actually visually recognized by the occupant e, it is possible to ensure the visibility of the virtual image 40 according to an actual traveling condition.

As one example, the brightness information on the determination area is classified into a scale of 1 to 10, the light intensity of each virtual image 40 superimposed on the display areas 53a, 53b, 53c is adjusted, and the virtual image 40 is projected with the contrast corresponding to the brightness information. As another example, the color tone information on the determination area is classified by a hue diagram or a chromaticity diagram, and the virtual image 40 is projected in a complementary color.

Alternatively, for example, the virtual image 40 is normally projected in red or yellow which is a warning color or in green with a high visibility, and when the color tone information on the determination area is red, yellow, or green, the color of the projected image is switched to another color such that the background and the virtual image 40 are not similar in color. Alternatively, the color tone of the determination area and the display color of the virtual image 40 may be recorded in advance in association with each other, and the image may be projected in red when the color tone information on the determination area is white on a snowy road and may be projected in green or blue when the color tone information is red or orange at the time of autumn foliage or sunset.

After the image adjustment unit 63 has adjusted the image information projected from the image projection unit 10 and has changed the brightness or color tone of the virtual image 40, the process proceeds to Step S6.

Step S6 is a projection continuation determination step of determining whether to continue projection of the virtual image 40. In a case where the projection is continued, the process proceeds to Step S1. In a case where the projection is not continued, the projection of the virtual image 40 from the image projection unit 10 is stopped and the process ends.

As described above, in the image projection system and the image projection method of the present embodiment, the outside condition imaging unit 50 captures the outside image, and the display image is adjusted and projected from the image projection unit 10 based on the analysis result of the image in the determination area. With this configuration, it is possible to understand superimposition of the virtual image 40 on the background in the actual field of view of the occupant e and to ensure the visibility of the virtual image 40 projected in superimposition with the background even under various traveling conditions.

Further, the image information on the virtual image 40 projected from the image projection unit 10 is adjusted according to the brightness information or color tone information on the determination area so that projection of the virtual image 40 can be properly controlled in real time under various conditions and the visibility of the virtual image 40 can be further enhanced.

### Second Embodiment

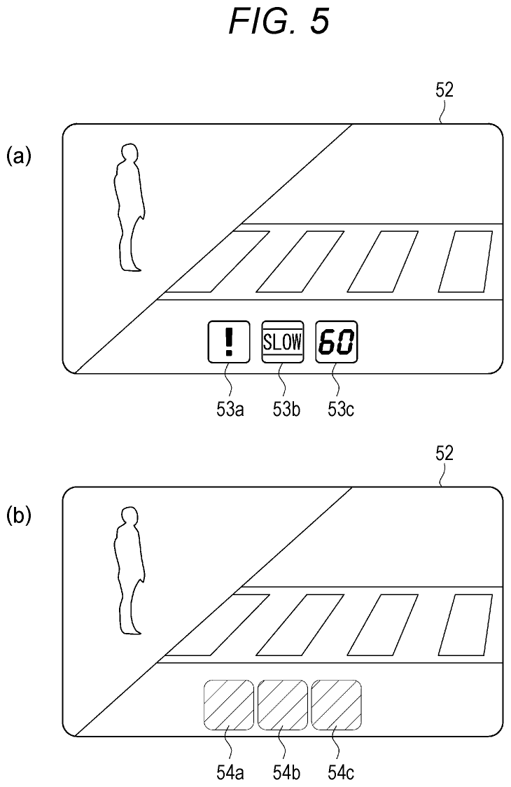

Next, a second embodiment of the present invention will be described with reference to FIG. 5. Description of contents overlapping with those of the first embodiment will be omitted. FIG. 5 is a schematic view showing a relationship between a display area and an outside image captured by an outside condition imaging unit 50 in an image projection system according to the present embodiment. FIG. 5(a) shows a plurality of display areas 53a to 53c in a determination area 52, and FIG. 5(b) shows sub-determination areas 54a to 54c corresponding to the display areas 53a to 53c.

As shown in FIGS. 5(a) and 5(b), in the present embodiment, there is the plurality of display areas 53a to 53c in the determination area 52, and the sub-determination areas 54a to 54c are each set in positions and sizes corresponding to the display areas 53a to 53c. Here, an example where the sub-determination areas 54a to 54c are included in the determination area 52 will be described, but the display areas 53a to 53c and the sub-determination areas 54a to 54c may be provided outside the determination area 52.

The sub-determination areas 54a to 54c are each set at positions corresponding to the display areas 53a to 53c, and are each set so as to include the display areas 53a to 53c. In addition, the determination area 52 and the sub-determination areas 54a to 54c are not used exclusively, but are independently set and analyzed by an image determination unit 62.

In the present embodiment, in an image determination step in Step S4, the image determination unit 62 sets the sub-determination areas 54a to 54c corresponding to the display areas 53a to 53c and the determination area 52 including all the display areas 53a to 53c. Moreover, the image determination unit 62 also acquires brightness information and color tone information for the determination area 52 and each of the sub-determination areas 54a to 54c.

In an image adjustment step in Step S5, an image adjustment unit 63 adjusts image information on each of the display areas 53a to 53c based on the brightness information and color tone information acquired on each of the sub-determination areas 54a to 54c as a result of analysis of the determination area by the image determination unit 62. At this point, the image adjustment unit 63 preferably individually adjusts the image information on the display areas 53a to 53c by image processing of a display image (virtual image 40).

As one example, based on the brightness information on each area, when the background is dark in the display areas 53a, 53b, but is bright in the display area 53c, image processing is performed such that the brightness is higher in the display area 53c than in the display areas 53a, 53b. Based on the color tone information on each area, when the color tone of the background is different among the display areas 53a, 53b, 53c, image processing is performed to change the color tone of each of the display areas 53a, 53b, 53c. The brightness information and color tone information on the sub-determination areas 54a to 54c are not necessarily individually used, but the image information may be adjusted with plural pieces of brightness information and color tone information associated with each other, including the determination area 52.

In the present embodiment, the brightness and color tone in each of the plurality of sub-determination areas 54a to 54c are understood and the brightness and color tone are individually adjusted in each of the display areas 53a to 53c, so that it is possible to ensure the visibility of the virtual image 40 projected in superposition with the background even under various traveling conditions.

### Third Embodiment

Next, a third embodiment of the present invention will be described. Description of contents overlapping with those of the first embodiment will be omitted. In the first embodiment, the image information is adjusted based on the single outside image captured by the image projection unit 10, but the present embodiment is different in that a plurality of outside images is captured and image information is adjusted based thereon.

In the present embodiment, in an outside condition imaging step in Step S1, an outside condition imaging unit 50 captures the plurality of outside images per unit time. The unit time and the number of images captured are not limited, and for example, are five images per second or 20 images in every three seconds. An image projection step in Step S2 and a display area specifying step in Step S3 are similar to those in the first embodiment.

In an image determination step in Step S4, an image determination unit 62 sets, as in the first embodiment, a determination area for the plurality of outside images, and analyzes an image in the determination area to acquire representative brightness information and color tone information for each of the plurality of outside images captured within a preset determination period. For example, there is a method in which the brightness information and the color tone information are acquired from the determination area for each outside image and the average values of the brightness information and the chromaticity information previously acquired for one second are used as representative values.

In an image adjustment step in Step S5, the image information is adjusted and light is emitted from the image projection unit 10 based on the representative brightness information and color tone information acquired in the image determination step. A projection continuation determination step in Step S6 is executed similarly to that in the first embodiment. FIG. 4 shows the example where the image projection step is executed as Step S2 after the outside condition imaging step, but the image projection step may be executed after the image adjustment step in Step S5. In addition, the order of execution of other steps may be changed as necessary.

In the image projection system and the image projection method of the present embodiment, since the representative brightness information and color tone information are acquired from the plurality of outside images captured in the determination period, the image information can be adjusted with a gentle change in a moving average value in the determination period. With this configuration, under, e.g., a condition where the background in the determination area temporarily rapidly changes, such as a condition where shadows of trees are dispersed on a road surface while a vehicle is traveling on an avenue, it is possible to restrain a rapid change in the brightness or color tone of a virtual image 40.

When the brightness or color tone of the virtual image 40 rapidly changes, an occupant e visually recognizes the virtual image 40 as blinking, and the visibility thereof is degraded. Thus, the image information is adjusted based on the plurality of outside images captured within the determination period so that the image information on the virtual image 40 can be more properly adjusted under various conditions and the visibility of the virtual image 40 can be further enhanced.

(Modification of Third Embodiment)

In the third embodiment, the determination period is set in advance, but may be variably set according to a condition. For example, the cycle of change in the brightness information and the color tone information may be calculated for the plurality of outside images, and the determination period may be set according to the change cycle.

The determination period may be set based on the contents of the image information to be projected as the virtual image 40. For example, the image to be projected as the virtual image 40 is ranked by urgency, and the determination period is set according to the rank. In the case of projecting an image which is highly required to quickly present information to the occupant e, it is preferable to shorten the determination period to instantaneously improve the visibility of the virtual image 40.

Alternatively, an outside condition may be acquired as condition information from a condition acquisition unit 64, and the determination period may be set based on the condition information. For example, a vehicle speed sensor is used as the condition acquisition unit 64, a vehicle traveling speed is acquired as the condition information, and the determination period is set according to the traveling speed. Consequently, the determination period can be shortened to immediately reflect adjustment of the image information during high-speed traveling, and the determination period can be lengthened to gently adjust the image information during low-speed traveling.

In the present modification, since the determination period is variably set according to the condition, the visibility of the virtual image 40 can be enhanced flexibly according to a condition change.

### Fourth Embodiment

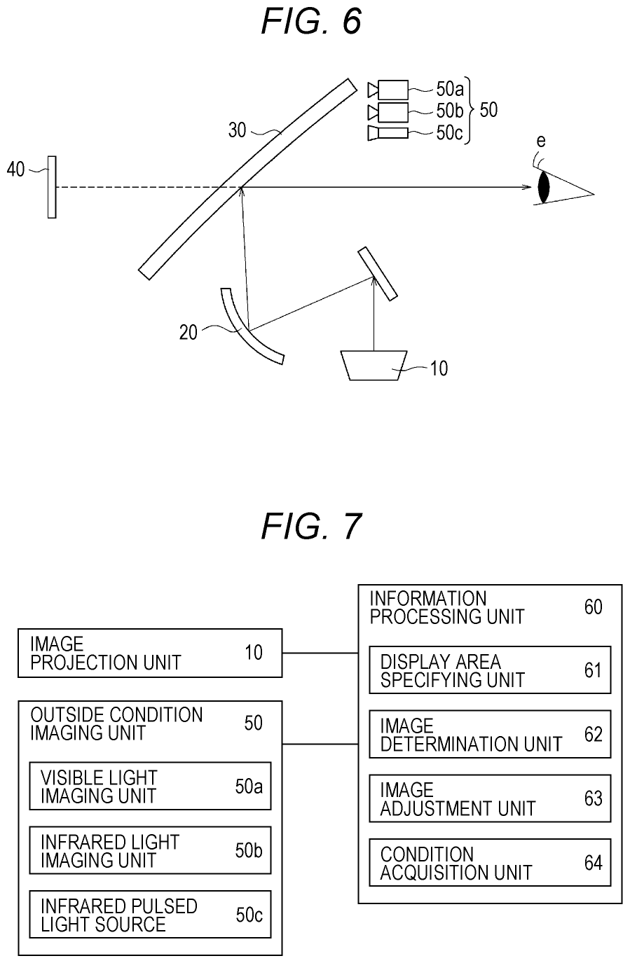

Next, a fourth embodiment of the present invention will be described with reference to FIGS. 6 to 10. Description of contents overlapping with those of the first embodiment will be omitted. FIG. 6 is a schematic view showing the configuration of an image projection system according to the present embodiment. FIG. 7 is a block diagram showing the configuration of the image projection system according to the present embodiment.

As shown in FIGS. 6 and 7, the image projection system of the present embodiment includes an image projection unit 10, a projection optical unit 20, a transmission reflection unit 30, an outside condition imaging unit 50, and an information processing unit 60, and projects a virtual image 40 to form an image in a space. The information processing unit 60 is connected to the image projection unit 10 and the outside condition imaging unit 50 so as to communicate information therebetween. In the present embodiment, the outside condition imaging unit 50 includes a visible light imaging unit 50a, an infrared light imaging unit 50b, and an infrared pulsed light source 50c.

The visible light imaging unit 50a is an imaging device that images an outside condition with visible light via the transmission reflection unit 30 and acquires a visible light image. The infrared light imaging unit 50b is an imaging device that images the outside condition with infrared light via the transmission reflection unit 30 and acquires an infrared light image. The configurations of the visible light imaging unit 50a and the infrared light imaging unit 50b are not limited, and a well-known imaging device such as a CCD sensor or a CMOS sensor can be used.

Although FIG. 6 shows an example where the visible light imaging unit 50a and the infrared light imaging unit 50b are provided separately, a visible light subpixel and an infrared light subpixel may be mixed in a single image sensor such as a CCD sensor or a CMOS sensor. Specifically, four or more subpixels may be provided in one pixel, RGB color filters may be arranged in three subpixels, and no color filter may be arranged in one subpixel. In this case, the subpixels provided with the RGB color filters can form the visible light imaging unit 50a, and the subpixel with no color filter can form the infrared light imaging unit 50b. Thus, the visible light image and the infrared light image can be captured with one image sensor.

The infrared pulsed light source 50c is a light source device that emits infrared light in a pulse form. The configuration of the infrared pulsed light source 50c is not limited, but in order to favorably emit the pulsed light having a small wavelength width and a small pulse width, it is preferable to pulse-drive an infrared laser light source.

In the present embodiment, since the infrared pulsed light source 50c emits the infrared pulsed light toward the outside, the infrared light imaging unit 50b can capture the infrared light image with the reflected infrared pulsed light. The visible light imaging unit 50a can capture the visible light image by receiving natural light or visible light of a headlight as in normal imaging. The outside condition imaging unit 50 transmits an outside image including the visible light image and the infrared light image to the information processing unit 60.

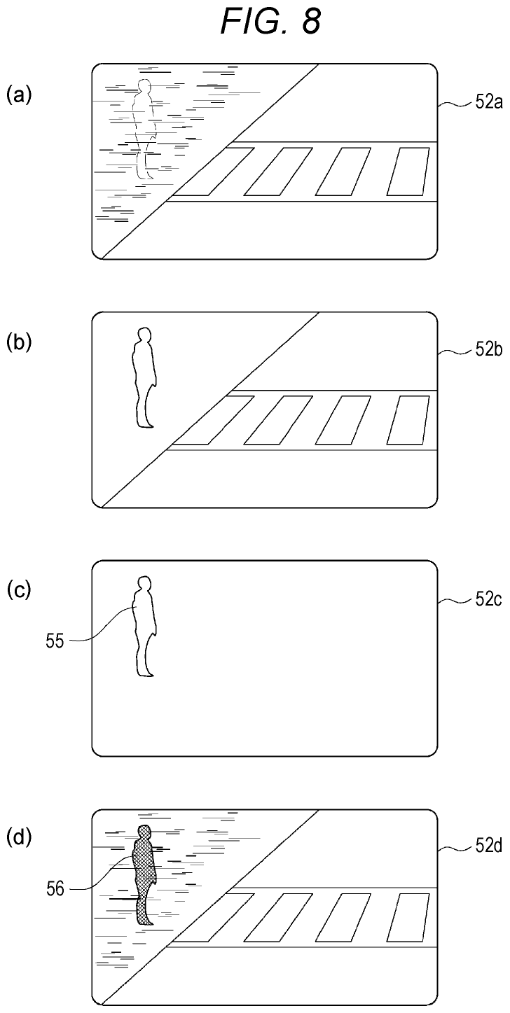

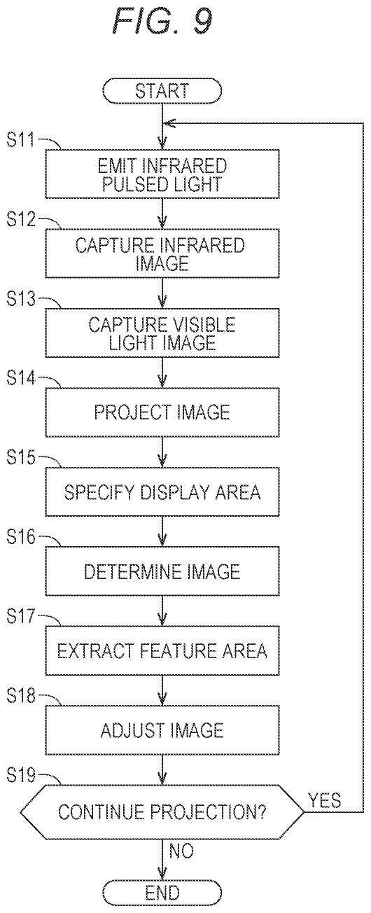

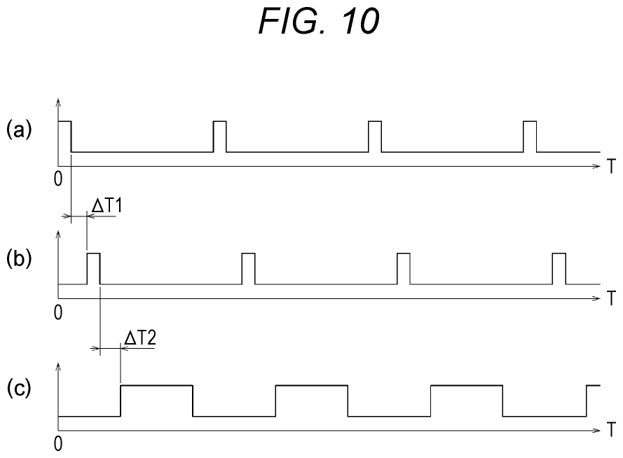

FIG. 8 is a schematic view showing a relationship between a determination area and a display area in the image projection system according to the present embodiment. FIG. 8(a) shows a determination area 52a in the visible light image. FIG. 8(b) shows a determination area 52b in the infrared light image. FIG. 8(c) shows a comparative image 52c of the visible light image and the infrared light image. FIG. 8(d) shows a point-of-view image 52d of an occupant e in which a virtual image 40 is superimposed on the background. FIG. 9 is a flowchart describing the procedure of an image projection method according to the present embodiment. FIG. 10 is a timing chart describing pulsed light emission and imaging in the present embodiment. FIG. 10(a) shows the timing of light emission from the infrared pulsed light source 50c, FIG. 10(b) shows the timing of imaging by the infrared light imaging unit 50b, and FIG. 10 (c) shows the timing of imaging by the visible light imaging unit 50a. The image projection method of the present embodiment is executed from Step S11 by the following procedure.

Step S11 is an infrared pulsed light emission step of emitting the infrared pulsed light from the infrared pulsed light source 50c to the outside. As shown in FIG. 10(a), the information processing unit 60 controls the infrared pulsed light source 50c to emit the infrared light with a predetermined pulse width to the outside, and the process proceeds to Step S12.

Step S12 is an infrared image capturing step of capturing the infrared light image by the infrared light imaging unit 50b. As shown in FIG. 10(b), the information processing unit 60 transmits a shutter control signal to the infrared light imaging unit 50b at a timing when ΔT1 (first delay time) has elapsed from the end of light emission from the infrared pulsed light source 50c, and captures the infrared light image with the infrared light which has been reflected on the background. After the infrared light image has been acquired, the process proceeds to Step S13.

Step S13 is a visible light image capturing step of capturing the visible light image by the visible light imaging unit 50a. As shown in FIG. 10(c), the information processing unit 60 transmits a shutter control signal to the visible light imaging unit 50a at a timing when ΔT2 (second delay time) has elapsed from the end of capturing of the infrared light image by the infrared light imaging unit 50b, and captures the visible light image with the visible light which has been reflected on the background. After the visible light image has been acquired, the process proceeds to Step S14. Note that ΔT1 (first delay time) and ΔT2 (second delay time) may be equal. Alternatively, the infrared light image may be captured, without ΔT2 (second delay time), during imaging of the visible light image.

The infrared light image captured in Step S12 and the visible light image captured in Step S13 are transmitted to the information processing unit 60, and information processing is performed for these images as the outside image including the visible light image and the infrared light image. Here, Steps S11 to S13 are the steps of capturing the infrared light image and the visible light image included in the outside image, and therefore, are equivalent to an outside condition imaging step in the present invention.

As shown in FIG. 8(a), since the visible light image is captured with the visible light which has been received by the visible light imaging unit 50a, a clear outside image may not be obtained in the area (left side in the drawing) where visible light from the background is insufficient. In a case where exposure is merely insufficient, exposure correction can be performed for the outside image, but the background cannot be imaged and correction cannot be performed depending on a weather condition such as rain or dense fog. In addition, noise increases due to the image obtained by exposure correction, and therefore, it is difficult to obtain a clear image.

On the other hand, in the infrared light image shown in FIG. 8(b), since the reflection of the pulsed light emitted from the infrared pulsed light source 50c is captured, the background can be clearly imaged by release of the shutter of the infrared light imaging unit 50b by the time when the reflected light comes back after emission of the pulsed light. In addition, the shutter of the infrared light imaging unit 50b is released at plural points of time after light emission from the infrared pulsed light source 50c, and the obtained plurality of images is superimposed, whereby the background at different distances can be clearly imaged as the infrared light image.

Step S14 is an image projection step of emitting the light including image information from the image projection unit 10 to form the virtual image 40 at a predetermined position. After the virtual image 40 has been acquired, the process proceeds to Step S15. Step S15 is a display area specifying step of specifying, as the display area, an area where a display image is projected so as to be superimposed in the outside image. In the present embodiment, since the irradiation position and contents of the virtual image 40 to be projected are determined based on the comparative image 52c extracted in an image determination step and a feature area extraction step as described later, an area where the virtual image 40 may be projected is set in advance as the display area. After a display area specifying unit 61 has specified the display area in the outside image, the process proceeds to Step S16.

Step S16 is the image determination step of setting the determination area including the display area in the outside image and recognizing and analyzing an image in the determination area. In the present embodiment, since the area where the virtual image 40 may be projected is set as the display area, an image determination unit 62 sets the entire area of the display area as the determination area, and the process proceeds to Step S17.

Step S17 is the specific area extraction step of extracting a feature area based on a difference between the visible light image and the infrared light image. Since the background actually visually recognized by the occupant e is equivalent to that captured as the visible light image, the occupant e cannot recognize the background in the area where the visible light is insufficient. In addition, since the infrared light image is acquired as a black-and-white image, it is difficult for the occupant e to recognize a target to be alerted from the background. For this reason, in the present embodiment, the image determination unit 62 compares and analyzes the determination area 52a in the visible light image of FIG. 8(a) and the determination area 52b in the infrared light image of FIG. 8(b).

FIG. 8(c) shows the comparative image 52c obtained in such a manner that the visible light image and the infrared light image in the determination areas 52a, 52b are compared with each other and a difference therebetween is extracted as a feature area 55. The background captured in both the visible light image and the infrared light image is removed from the comparative image 52c, and the comparative image 52c includes only the feature area 55 as the difference. After the image determination unit 62 has acquired the comparative image 52c and the feature area 55, the process proceeds to Step S18.

Step S18 is an image adjustment step of adjusting the image information on the virtual image 40 projected from the image projection unit 10 based on the analysis result in the image determination step and the feature area extraction step. The image adjustment unit 63 superimposes and synthesizes the feature area 55 extracted by the image determination unit 62 on the image information, and projects the image from the image projection unit 10. The image determination unit 62 may acquire brightness information and color tone information on the determination area 52a of the visible light image as in the first embodiment, and the image adjustment unit 63 may adjust the brightness and color tone of the feature area 55.

At this point, the irradiation position of the feature area 55 is set such that the position in the infrared light image, the position in the visible light image, and the position of the field of view of the occupant e are coincident with each other. Thus, as shown in FIG. 8(d), the point-of-view image 52d from the point-of-view position of the occupant e includes the feature area 55 superimposed on the background, and a target which is difficult to be visually recognized with only the visible light can be presented to the occupant e. Further, the brightness and color tone of the virtual image 40 of the feature area 55 superimposed on the real background are adjusted so that the visibility can be improved as compared with that when the infrared light image is projected as-is.

Step S19 is a projection continuation determination step of determining whether to continue projection of the virtual image 40. In a case where the projection is continued, the process proceeds to Step S1. In a case where the projection is not continued, the projection of the virtual image 40 from the image projection unit 10 is stopped and the process ends. FIG. 9 shows the example where the image projection step is executed as Step S14 after the visible light image capturing step, but the image projection step may be executed after the image adjustment step in Step S18. In addition, the order of execution of other steps may be changed as necessary.

As described above, in the image projection system and the image projection method of the present embodiment, the outside condition imaging unit 50 captures the outside image including the visible light image and the infrared light image, and the display image is adjusted and projected from the image projection unit 10 based on the feature area 55 obtained as a result of analysis of the image in the determination area. With this configuration, the virtual image 40 can be superimposed and presented on the background even for a target which cannot be visually recognized by the viewer e with the eyes thereof.

Further, the image information on the virtual image 40 projected from the image projection unit 10 is adjusted according to the brightness information or color tone information on the determination area so that projection of the virtual image 40 can be properly controlled in real time under various conditions and the visibility of the virtual image 40 can be further enhanced.

The present invention is not limited to each of the above-described embodiments, and various changes can be made within the scope of the claims. Embodiments obtained by appropriately combining techniques disclosed in different embodiments are also included in the technical scope of the present invention.

The present international application claims priority based on Japanese Patent Application No. 2020-206894 filed on Dec. 14, 2020, and the entire contents of Japanese Patent Application No. 2020-206894 are incorporated herein by reference.

The above description of the specific embodiments of the present invention has been made for illustrative purposes. Such description is not intended to be exhaustive or limit the present invention to the forms described. It is obvious to those skilled in the art that many modifications and changes can be made in light of the above description.

### LIST OF REFERENCE SIGNS

10 Image Projection Unit
20 Projection Optical Unit
30 Transmission Reflection Unit
40 Virtual Image
50 Outside Condition Imaging Unit
60 Information Processing Unit
50a Visible Light Imaging Unit
50b Infrared Light Imaging Unit
50c Infrared Pulsed Light Source
51 Outside Image
52,52a,52b Determination Area
52c Comparative Image
52d Point-of-view Image
53a to 53c Display Area
54a to 54c Sub-determination Area
55 Feature Area
61 Display Area Specifying Unit
62 Image Determination Unit
63 Image Adjustment Unit
64 Condition Acquisition Unit

What is claimed is:

1. An image projection system comprising:
a transmission reflection unit that includes a translucent member;
an image projection unit that irradiates an inner surface of the transmission reflection unit with light including image information to project a display image;
an outside condition imaging unit that images, as an outside image, a condition outside the transmission reflection unit;
a display area specifying unit that specifies a display area where the display image is projected in the outside image;
an image determination unit that sets a determination area including the display area and recognizes and analyzes an image in the determination area in the outside image; and
an image adjustment unit that adjusts the image information based on an analysis result of the image determination unit.

2. The image projection system according to claim 1, wherein
a plurality of the display areas and a plurality of the determination areas are provided.

3. The image projection system according to claim 1, wherein
the image determination unit acquires brightness information in the determination area, and
the image adjustment unit adjusts a brightness of the image information based on the brightness information.

4. The image projection system according to claim 1, wherein
the image determination unit acquires color tone information in the determination area, and
the image adjustment unit adjusts a color tone of the image information based on the color tone information.

5. The image projection system according to claim 1, wherein
the image determination unit analyzes a plurality of images in the determination area within a determination period.

6. The image projection system according to claim 5, wherein
the image determination unit sets the determination period based on the image information.

7. The image projection system according to claim 5, further comprising:
a condition acquisition unit that acquires an outside condition as condition information,
wherein the image determination unit sets the determination period based on the condition information.

8. The image projection system according to claim 1, wherein
the outside condition imaging unit includes a visible light imaging unit that captures a visible light image with visible light and an infrared light imaging unit that captures an infrared light image with infrared light, and
the outside image includes the visible light image and the infrared light image.

9. The image projection system according to claim 8, wherein
the infrared light imaging unit includes an infrared pulsed light source that emits the infrared light in a pulse form, and
the infrared light image is captured after a first delay time has elapsed from an end of light emission from the infrared pulsed light source.

10. The image projection system according to claim 9, wherein
the visible light image is captured after a second delay time has elapsed from an end of capturing of the infrared light image.

11. The image projection system according to claim 8, wherein
the image adjustment unit superimposes at least part of the infrared light image on the image information.

12. The image projection system according to claim 11, wherein
the image determination unit extracts a feature area based on a difference between the visible light image and the infrared light image, and
the image adjustment unit superimposes the feature area on the image information.

13. The image projection system according to claim 8, wherein
the infrared light imaging unit and the visible light imaging unit are configured such that a visible light subpixel and an infrared light subpixel are mixed in a single image sensor.

14. The image projection system according to claim 1, wherein
the transmission reflection unit is a windshield of a vehicle.

15. An image projection method comprising:
an image projection step of irradiating an inner surface of a transmission reflection unit, which includes a translucent member, with light including image information to project a display image;
an outside condition imaging step of imaging, as an outside image, a condition outside the transmission reflection unit;
a display area specifying step of specifying a display area where the display image is projected in the outside image;
an image determination step of setting a determination area including the display area and recognizing and analyzing an image in the determination area in the outside image; and
an image adjustment step of adjusting the image information based on an analysis result of the image determination step.
